(19) United States
(12) Patent Application Publication
(10) Pub. No.: US 2018/0309156 A1
(43) Pub. Date: Oct. 25, 2018

(54) METAL-ION RECHARGEABLE CELL OR BATTERY

(71) Applicant: Sharp Kabushiki Kaisha, Osaka (JP)

(72) Inventors: Katherine Louise SMITH, Oxford (GB); Emma KENDRICK, Oxford (GB)

(21) Appl. No.: 15/765,555

(22) PCT Filed: Oct. 28, 2016
(86) PCT No.: PCT/JP2016/004751

§ 371 Date: Apr. 3, 2018

(30) Foreign Application Priority Data
Oct. 30, 2015 (GB) 1519253.7

(51) Int. Cl. H01M 10/054; H01M 10/0525; H01M 4/38; H01M 4/62; H01M 4/66; H01M 4/587

(52) U.S. Cl. CPC H01M 10/054; H01M 10/0525; H01M 4/587; H01M 4/625; H01M 4/667; H01M 4/382

(57) ABSTRACT

A metal-ion electrochemical cell contains a composite anode (40) comprising a support matrix (40a) and electrochemically active metal droplets (40b) dispersed through the support matrix (40a). The metal droplets have a melting point of 100° C. or lower, and may have a melting point of 40° C. or lower or a melting point of 20° C. or lower. The cell also includes a composite cathode (60) containing an intercalation material for the metal, and a conducting electrolyte medium (50) located between the anode and the cathode. The metal-ion consists of one or more of: sodium, zinc, magnesium, aluminium and calcium. In another embodiment, the cell further contains a conductive spacer layer disposed between the anode current collector and the composite anode. In this embodiment the metal-ion may consist of one or more of: lithium, sodium, zinc, magnesium, aluminium and calcium.

### TECHNICAL FIELD

One aspect of this invention relates to metal-ion cell or batteries that store electrical energy and provide electrical energy.

### BACKGROUND ART

Metal-ion cells are a family of rechargeable cell types which are capable of storing and providing energy. In its most basic form a cell comprises an anode (negative electrode), a cathode (positive electrode) and an electrolyte material and this may be considered as a “cell unit”. A “cell stack” consists of multiple cell units stacked vertically and/or horizontally. Multiple cell units or multiple cell stacks may be used in conjunction to form a battery.

The most widespread example of a metal-ion battery is the lithium ion battery. Lithium-ion batteries are widely used in consumer electronic devices and are also growing in popularity in other applications such as electric vehicles. Metal-ion batteries all have the same basic structure and charge and discharge via a similar reaction mechanism. For example when a lithium-ion battery is charging Li⁺ ions deintercalate from the cathode and insert into the anode. Meanwhile charge balancing electrons pass from the cathode through the external circuit containing the charger and into the anode of the battery. During discharge the same process occurs but in the opposite direction with the external circuit able to power a load. Sodium-ion batteries are analogous in many ways to the lithium-ion batteries that are in common use today, but a sodium ion Na⁺ shuttles between the cathode and anode in place of the lithium ions Li⁺. Lithium is not a cheap metal to source and is considered too expensive for use in large scale applications. By contrast sodium-ion battery technology is still in its relative infancy but is seen as potentially advantageous; sodium is much more abundant than lithium and some researchers predict this will provide a cheaper and more durable way to store energy into the future, particularly for large scale applications such as storing energy on the electrical grid.

The parts of the electrode which the metal ions either intercalate into or alloy with or are held on the surface of or are held within the pores of are referred to as an active material in the battery. In contrast other components may be present for example as a substrate to support the active material, as a conductive additive, to bind the electrode components together or to promote adhesion or flexibility. There is a general drive to increase the energy density of the active materials in metal-ion batteries. A greater storage capacity in the active materials allows for either a smaller battery size in a device, extra energy available to the device being powered or for a greater battery life between charges. In addition to battery capacity the cycle life of a battery is also an important factor, with many applications demanding hundreds or in some cases thousands of cycles with only a small fraction of the initial capacity becoming unusable. The main approaches which can increase the energy density of metal-ion batteries are either to develop high voltage cathode active materials or by developing high capacity anode and cathode active materials.

The energy density of an electrochemical cell can be specified either in Wh/Kg for the gravimetric energy density or in Wh/1 for the volumetric energy density. The performance of the active materials contained in the anode or cathode can be characterised by a specific charge or discharge capacity, usually referred to just as “specific capacity”, which again may be either a specific gravimetric capacity or a specific volumetric capacity (mAh/g, mAh/cm³). An ideal anode active material has a high specific capacity and a low electrochemical potential. The lower electrochemical potential allows for a higher voltage available to the external circuit when the anode is placed against a cathode material within a battery cell, and the higher specific capacities allow the intercalation or alloying of more of the metal ions.

For example in some respects lithium metal is an ideal anode material for lithium ion rechargeable batteries due to its high gravimetric specific capacity (3860 mAh/g) and low negative electrochemical potential (−3V v standard hydrogen electrode). Although lithium metal anode batteries are known, there are problems in secondary cells, such as the requirement for at least a three-fold of excess of lithium, and the poor cycle life due the formation of lithium dendrites on the anode surface which also creates a safety hazard due to the risk of creating a short circuit within the battery.

Sodium metal anode batteries are also known, in particular the high temperature Sodium Sulfur batteries, or the ZEBRA batteries. Both of these types of batteries contain a sodium metal anode, and a sodium-beta alumina ceramic separator. They are generally operated at high temperatures of 300-350° C. because of the low conductivity of the ceramic ionic conductor. In these cases the sodium metal is a liquid, and due to the ceramic separator and surface tension of the molten sodium dendrites do not form in these systems. Some lower temperature systems have been developed wherein the anode is a mixed alkali metal eutectic. These mixed alkali metal systems form a low temperature eutectic, which means the metal mixture metal at much lower temperatures, and in some cases is a liquid at room temperature. These lower temperature sodium beta alumina type batteries have benefits due to the lower operating temperature.

The most popular anode for room temperature lithium-ion batteries is graphite. The positive features of graphite are a flat and low working potential versus lithium, however the intercalation of lithium into graphite is limited to only one lithium ion for every six carbon atoms, 6C+Li⁺+e⁻→LiC₆ with a resulting reversible capacity of 372 mAhg⁻¹. For sodium-ion batteries the larger sodium ions cause exfoliation of the graphite anode and other forms of carbon such as hard carbon (also known as amorphous carbon) or expanded graphite oxide are often used. These materials have a specific capacity of approximately 250-300 mAhg⁻¹ with an average voltage of approximately 0.2V vs Na. To achieve high cycling efficiency and long cycle life, the movement of sodium ions into and out of the cathode and anode active materials should not change or damage the crystal structure. It is expected that with other anode material such as metal oxides or metal alloys, which intercalate or alloy with sodium, the specific capacity of the anode will be increased and hence the energy density of the cell.

Many of the metals and metal alloys have large theoretical capacities. One problem with these materials is the large volume changes which accompany the alloying of the metal ions with the metal or metal alloy anode, this causes pulverisation of the metal or metal alloy particles and rapid capacity fade of the battery cells. The use of nanostructured electrodes may provide room for this expansion and reduce the extent of pulverisation, thereby increasing the cycle life, and have been studied for lithium ion and sodium ion batteries.

The use of nano-composites as anode materials in metal-ion batteries has also been studied, for example tin-graphite or silicon-graphite composites. Also described in the literature is the use of a carbon matrix with higher capacity anode active material particles, wherein the presence of a conductive carbon matrix can absorb the large volume changes during cycling, with an improved cycle life reported for increasing carbon content.

It is shown in the prior art that a high specific capacity anode material, such as a metal or metal alloy has benefits in terms of the large specific capacities, however issues arise with pulverisation of these materials during cycling and hence poor reversibility, and the formation of dendrites with the alkali metals. To solve this problem there are some examples where a liquid anode has been used in an electrochemical cell.

In some cases high temperatures are required to melt the metal and U.S. Pat. No. 6,120,933A describes a self-recharging molten salt electrochemical cell with a liquid anode. U.S. Pat. No. 3,245,836 discloses a fuel cell, or regenerative molten salt battery having a positive electrode of a molten metal selected from the group consisting of lead, tin, mercury, bismuth, cadmium, gallium, and antimony, and a negative electrode of a molten metal selected from the group consisting of sodium, potassium, rubidium, lithium, calcium, and magnesium, this is typically operated at temperature greater than 500° C. US2008/0044725 describes a high temperature liquid electrode battery consisting of three liquid material layers of positive electrode, electrolyte, and negative electrode, which separate according to their densities. In addition to these batteries U.S. Pat. No. 8,679,621B2 discloses embedding liquid metal filled microcapsules into electrodes. In this case the liquid is not electrochemically active but designed to repair mechanical damage that occurs to a device during operation.

In some cases batteries can contain low temperature liquid anodes. U.S. Pat. No. 8,586,227B2 proposes a sodium-beta alumina battery. This operates below 30° C. with a molten sodium eutectic anode, for example NaCs, NaK or NaRb. In these systems the cathode is also a material that is in a liquid state at ambient temperature, such as a sulphur alloy (S—Br, S—I) or a low melting point ionic liquid such as FeCl₂, NaAlCl₄ and THF (Tetrahydrofuran). WO2011154869A2 proposes a sodium-air battery which includes an anode comprising molten sodium. WO2011154869 proposes operating the cell at an operating temperature greater than the melting point of sodium (97.8° C.), for example between 105° C. and 110° C., to ensure the Na anode is liquid. US2010/0047671A1 proposes a redox flow device in which at least one of the positive electrode or negative electrode active materials is a semi-solid (that is, is a mixture of liquid and solid phases).

In particular U.S. Pat. No. 8,841,014 proposes an electrode for a lithium-ion battery that includes a liquid metal having a melting point below the operating temperature of the battery, such that the electrode that can undergo liquid-to-solid phase transformation upon lithiation as a result of the formation of high melting point intermetallics. The electrode also undergoes solid-to liquid phase transformation during delithiation, returning the electrode to the initial liquid state. Examples of electrodes include gallium and alloys of gallium, indium and/or tin. Materials may be mixed with the liquid metal to form an anode or to form a cathode. The aim of the design is to allow self-healing of cracks which are formed during the solid state and thereby improve the durability of the device. U.S. Pat. No. 8,642,201 and US20120244418 propose a liquid metal alloy negative electrode for a lithium-ion battery. The liquid metal alloy is absorbed in a porous matrix made of polymers, hydrogels or ceramics where the liquid metal alloy for the negative electrode is a liquid at the operating temperature of the device. The liquid metal alloy is for example an alloy of the Sn—In—Bi—Ga system. The porous matrix is not electrochemically active. U.S. Pat. No. 8,658,295 proposes self-healing lithium-ion battery negative electrodes. The negative electrode comprises an alloy with a melting point below 150° C., such as Sn alloyed to Bi and/or In, such that the layer can self-heal by periodically being warmed to near its melting point and therefore substantially removing any cracks in the negative electrode (but in normal operation of the battery the negative electrode is solid). Lee et al Electrochemical and Solid-State Letters, 11 (3) A21-A24 (2008) discloses a liquid gallium electrode confined in a porous carbon matrix in a lithium ion battery where the gallium is a liquid during the operation of the battery with the aim of creating a self-healing anode. The use of the porous carbon is to confine the LiₓGa particles at the void space to minimize their detachment.

Eutectic alloys have two or more components and have a eutectic composition. The eutectic composition for an alloy is the composition at which all the components will melt or freeze at the same temperature and this temperature will be lower than for any other composition of the components. The use of alloys of low melting temperature metals can lower the melting temperature compared with any of the pure elements. Therefore the use of eutectic alloys is useful where a low melting temperature is desirable. Some low melting temperature alloys contain combinations of gallium, indium, tin, antimony, bismuth, lead, cadmium, zinc and thallium. Other low melting temperature metals/alloys include Hg, CsK, NaK, NaCs and NaRb.

Gallium metal is quite corrosive to most other metals because of the rapidity with which it diffuses into the crystal lattices of metals. For example, only a very small amount of gallium in contact with an aluminium plate or sheet will result in immediate embrittlement as the result of the diffusion of gallium through the grain boundaries separating them. The few metals that tend to resist attack by gallium are molybdenum, niobium, tantalum and tungsten (Van Nostrand's Scientific Encyclopaedia by Douglas M. Considine and Gelnn D. Considine p. 1401).

### CITATION LIST

### Patent Literature

PTL 1: U.S. Pat. No. 6,120,933A
PTL 2: U.S. Pat. No. 3,245,836
PTL 3: US2008/0044725
PTL 4: U.S. Pat. No. 8,679,621B2
PTL 5: U.S. Pat. No. 8,586,227B2
PTL 6: WO2011154869A2
PTL 7: WO2011154869
PTL 8: US2010/0047671A1
PTL 9: U.S. Pat. No. 8,841,014
PTL 10: U.S. Pat. No. 8,642,201
PTL 11: US20120244418

### Non Patent Literature

NPL 1: Lee et al Electrochemical and Solid-State Letters, 11 (3) A21-A24 (2008)

### SUMMARY OF INVENTION

A first aspect of the invention provides a metal-ion electrochemical cell containing: a composite anode comprising a support matrix and electrochemically active metal droplets dispersed through the support matrix, the metal droplets having a melting point below 100° C.; a composite cathode containing an intercalation material for the metal ion; and a conducting electrolyte medium located between the anode and the cathode; wherein the metal ion consists of one or more of: sodium, zinc, magnesium, aluminium and calcium.

A second aspect of the invention provides a metal-ion electrochemical cell containing: an anode current collector; a composite anode comprising a support matrix and electrochemically active metal droplets dispersed through the support matrix, the metal droplets having a melting point below 100° C.; a composite cathode containing a intercalation material for the metal ion; a conducting electrolyte medium located between the anode and the cathode; and a conductive spacer layer disposed between the anode current collector and the composite anode.

In the annexed drawings, like references indicate like parts or features.

### BRIEF DESCRIPTION OF DRAWINGS

FIG. 1 shows a metal-ion cell with a single cathode layer and a composite anode layer. The composite anode layer is separated from the metallic anode current collector by a conductive spacer layer.

FIG. 2 shows a metal-ion cell stack with multiple cathode layers and multiple composite anode layers. The composite anode layers are separated from the metallic anode current collectors by a conductive spacer layers. The repeating unit to form larger stacks is also shown.

FIG. 3 shows a schematic of the composite anode electrode, where the supporting matrix (40a) hosts the liquid electrochemically active anode particles (40b), and the composite electrode also contains conductive additive (40c), a second electrochemically active material (40d) and a binder (40e). The electrode is adhered to a conductive inter-spacer layer (30) upon an anodic current collector (20).

FIG. 4 shows the liquid particles (40b) surrounded by the matrix particles (40a). The matrix particles (40a) may or may not completely enclose the liquid particles (40b).

FIG. 5 shows the matrix particles (40a) coated with the liquid particles (40b). The liquid particles (40b) may or may not completely enclose the matrix particles (40a).

FIG. 6 shows a composite anode layer (40) with separate particles of the matrix component (40a) and liquid component (40b).

FIG. 7 shows a composite anode layer (40) with the liquid particles (40b) coated with the matrix component (40a).

FIG. 8 shows a composite anode layer (40) with the liquid particles (40b) coated with the matrix component (40a) and additionally separate matrix particles (40a).

FIG. 9 shows a composite anode layer (40) with the liquid particles (40b) coated with the matrix component (40a) and additionally separate liquid particles (40b).

FIG. 10 shows a composite anode layer (40) with the liquid particles (40b) coated with the matrix component (40a) and additionally separate liquid particles (40b) and additionally separate matrix particles (40a).

FIG. 11 shows a composite anode layer (40) with the matrix particles (40a) coated with the liquid component (40b).

FIG. 12 shows a composite anode layer (40) with the matrix particles (40a) coated with the liquid component (40b) and additionally separate liquid particles (40b).

FIG. 13 shows a composite anode layer (40) with the matrix particles (40a) coated with the liquid component (40b) and additionally separate matrix particles (40a).

FIG. 14 shows a composite anode layer (40) with the matrix particles (40a) coated with the liquid component (40b) and additionally separate liquid particles (40b) and additionally separate matrix particles (40a).

FIG. 15 shows a composite anode layer (40) with the liquid particles (40b) coated with the matrix component (40a) and additionally the matrix particles (40a) coated with the liquid component (40b).

FIG. 16 shows a composite anode layer (40) with the liquid particles (40b) coated with the matrix component (40a) and additionally the matrix particles (40a) coated with the liquid component (40b) and additionally separate liquid particles (40b).

FIG. 17 shows a composite anode layer (40) with the liquid particles (40b) coated with the matrix component (40a) and additionally the matrix particles (40a) coated with the liquid component (40b) and additionally separate matrix particles (40a).

FIG. 18 shows a composite anode layer (40) with the liquid particles (40b) coated with the matrix component (40a) and additionally the matrix particles (40a) coated with the liquid component (40b) and additionally separate liquid particles (40b) and additionally separate matrix particles (40a).

FIG. 19 shows a metal-ion cell stack with multiple cathode layers and multiple composite anode layers. The composite anode layers (40) are separated from the metallic anode current collectors (20) by conductive spacer layers (30). The composite anode layers (40) are separated from the separator (50) by conductive spacer layers (45). The repeating unit to form larger stacks is also shown.

FIG. 20 shows a sodium ion cell stack according to an embodiment of the present invention.

FIG. 21 shows EDS images showing successful incorporation of a gallium indium liquid into a carbon matrix. Image (a) shows the gallium content and image (b) shows the indium content. The overlap of the gallium and indium locations show the successful eutectic mixture. The liquid alloy composition was Ga_{0.755}In_{0.245}.

FIG. 22 shows EDS images showing successful incorporation of a gallium indium liquid into a carbon matrix. Image (a) shows the gallium content, image (b) shows the indium content and image (c) shows the tin content. The overlap of the gallium, indium and tin locations show the successful eutectic mixture. The liquid alloy composition was Ga_{0.62}Sn_{0.16}Pb_{0.22}.

FIG. 23 shows EDS images showing successful incorporation of a gallium indium liquid into a carbon matrix. Image (a) shows the indium content, image (b) shows the tin content and image (c) shows the lead content. The overlap of the indium, tin and lead locations show the successful eutectic mixture. The liquid alloy composition was In_{0.51}Sn_{0.165}Pb_{0.325}.

### DESCRIPTION OF EMBODIMENTS

In the following description an active material describes a component of either a cathode or an anode which contributes to the capacity of the electrode. The cathode is the positive electrode of the cell and the anode is the negative electrode of the cell. A liquid, active component refers to a component of an electrode which is electrochemically active and therefore either inserts, hosts, alloys with or mixes with the metal ions which are moving between the cathode and anode and is a liquid for at least part of an electrochemical cycle when the cell is at a temperature below 100° C.

One or more cells of embodiments of the invention may be incorporated into a battery.

The term “particle” as used herein is not intended to limit the scope of the invention and, unless specified to the contrary, may include a solid or liquid of any size or shape.

The term “matrix particle” as used herein refers to a non-liquid component of the composite anode which hosts the liquid component and may or may not also contribute to the capacity of the anode.

### Example 1

An embodiment of this invention relates to a reversible metal-ion cell which incorporates an electrode of one embodiment of the present invention and which may be repeatedly charged and discharged, to store energy upon charge and produce energy during the discharge.

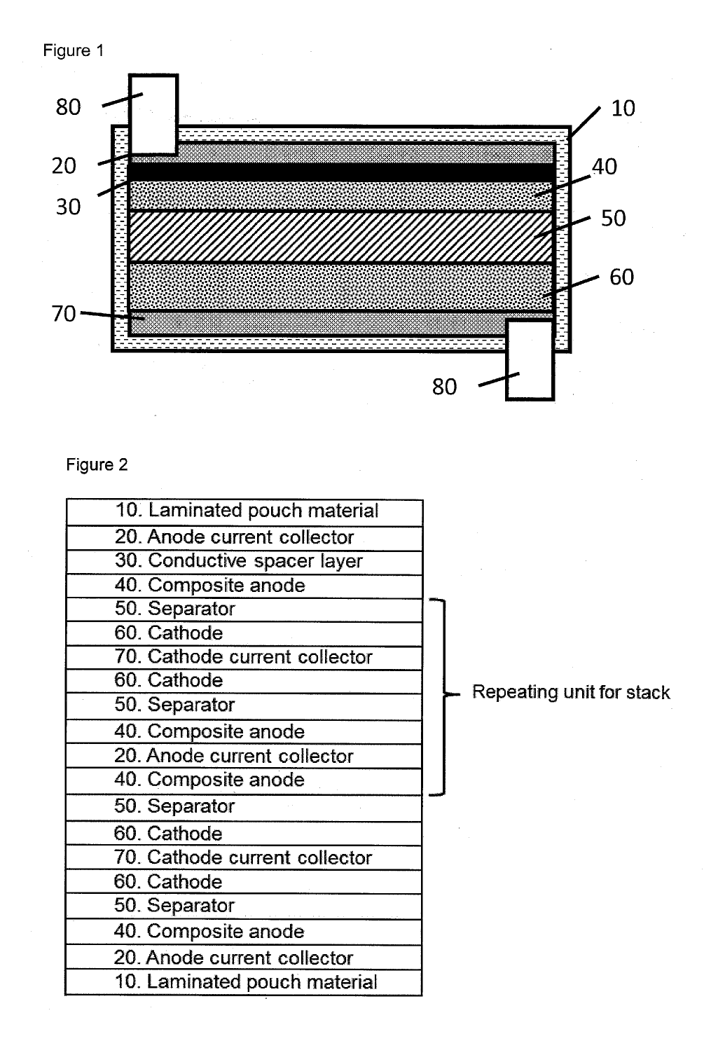

The present invention is not limited to a particular cell format. The battery format for embodiments of the present invention may include but is not limited to cylindrical cells, button cells, prismatic cells and pouch cells. In FIG. 1, the cell is shown as a pouch cell format. The electrode stack is contained within a laminated pouch material (10) which prevents short circuit paths, protects the cell components from reactions with air or moisture and contains the cell components within the package. Within the pouch cell (10) there is an electrode stack made of a plurality of anode and cathode layers.

As described in FIG. 1, the cell is comprised of an anode of an embodiment of this invention (40) and consists of at least a solid active component and a liquid active component and may in addition contain additives for binding the components together and improvement in conduction, increasing conductivity or other functions. The cell also contains a cathode which incorporates a metal intercalation material (60), an ionically conducting electrolyte medium and separator (50), which is sandwiched between the anode (40) and cathode (60). The anode (40) is supported by an anodic current collector (20) and the cathode (60) by a cathodic current collector (70). The anodic current collector (20) may be coated with a protective layer (30). The cell is placed inside a container (10), which may be laminated aluminium, which prevents short circuits and protects the cell from the air. The anode and cathode are connected to an external circuit via tabs (80) which remove and input the electrons into the cell.

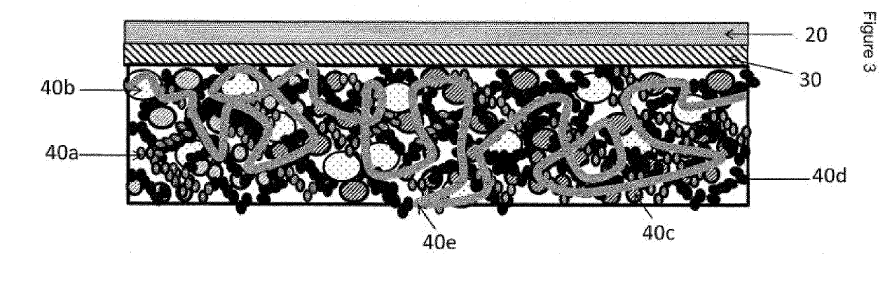

A further example is to build up a larger cell stack of to increase the capacity of the cell stack as shown in FIG. 2 where the repeating sequence required to further build up the cell stack is shown.

The separator (50) may be comprised of a thin film which is soaked in a liquid electrolyte. The separator (50) may be comprised of a porous film, a non-woven fabric, and a woven fabric, and is made of a material of a polyolefin resin such as polyethylene and polypropylene, a fluororesin, nylon, and an aromatic aramid can be used, or in some cases cellulosic fibres or material. The thickness of the separator (50) is usually about 10 to 200 μm, and preferably 10 to 30 μm. The separator (50) may be a combination such that separators having differing porosities are laminated. The separator (50) may additionally contain a coating of ceramic, PVDF, a surfactant chemical or any combination thereof. Alternatively the separator layer (50) may be a ceramic separator, this ceramic separator may for example contain ceramic particles blended with PVDF polymer or may be made by a different method. Alternatively the separator layer (50) may be a polymer or gel electrolyte, such as polyethylene oxide (PEO), or a block or co polymer such as polyethylene oxide-co-propylene oxide) acrylate. In some embodiments the polymer may be plasticised with a solvent such as propylene carbonate, dimethyl sulfoxide, ethylene glycol, triethylamine, DMF (dimethylformamide), DMSO (dimethyl sulphoxide), polyethoxide ether, poly ethylene succinate, aprotic organic solvents.

The separator layer (50) in some embodiments also contains a liquid electrolyte. Alternatively in the case of a gel electrolyte, the separator layer may constitute the electrolyte—that is a gel electrolyte layer may also act as a separator. The electrolyte material(s) may be any conventional or known material(s) and may comprise either aqueous electrolyte(s) or non-aqueous electrolyte(s) or mixtures thereof. The electrolyte medium may include at least one of an ionic liquid. Examples of solvents usable in the non-aqueous electrolyte of a sodium-ion or lithium-ion secondary battery of an embodiment of the present invention include carbonates such as propylene carbonate (PC), ethylene carbonate (EC), vinylene carbonate, dimethyl carbonate (DMC), diethyl carbonate, ethyl methyl carbonate, isopropyl methyl carbonate, 4-trifluoromethyl-1,3-dioxolan-2-one, and 1,2-di(methoxycarbonyloxy)ethane; ethers such as 1,2-dimethoxyethane, 1,3-dimethoxypropane, pentafluoro propyl methyl ether, 2,2,3,3-tetrafluoropropyl difluoromethyl ether, tetrahydrofuran, and 2-methyltetrahydrofuran; esters such as methyl formate, methyl acetate, and ybutyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, 1,3-propane sultone, ethylene sulfite, propylene sulfite, dimethyl sulfite, and diethyl sulfite; and those obtained by introducing a fluorine substituent into the abovedescribed organic solvents. Usually, two or more kinds of these solvents are mixed and used. Among these, preferred is a mixed solvent containing carbonates, and more preferred is a mixed solvent of a cyclic carbonate and a non-cyclic carbonate or a mixed solvent of a cyclic carbonate and ethers. These electrolyte solvents advantageously contain an alkali metal conducting salt with a weakly bound cation such as perchlorate ClO₄⁻, PF₆⁻, triflate (CF₃SO₃)⁻, bis(oxalato) borate (BC₄O₈⁻, BOB) or imide/TFSI (N(SO₂CF₃)₂).

Ionic liquid electrolytes may be comprised of one or more of the following salts 1-ethyl-3-methylimidazolium bis(trifluoromethylsulfonyl)imide; 1-ethyl-3-methylimidazolium tetrafluoroborate; 1-butyl-3-methylimidazoliumbis(trifluoromethylsulfonyl)imide; 1-butyl-3-methylimidazolium tetrafluoroborate; 1-hexyl-3-methylimidazolium; bis(trifluoromethylsulfonyl)imide; 1-hexyl-3-methylimidazolium tetrafluoroborate; 1-butyl-2,3-dimethylimidazolium bis(trifluoromethylsulfonyl)imide; 1-butyl-2,3-dimethylimidazolium tetrafluoroborate; N-octylpyridinium tetrafluoroborate; N-butyl-4-methylpyridinium tetrafluoroborate; and N-butyl-4-methylpyridinium hexafluorophosphate. Ionic liquids included in electrolyte medium may comprise cations of the pyridine and pyrrollidinium group such as: methyl-1-propyl pyrrolidinium [MPPyrro]⁺, 1-methyl-1-butyl pyrrolidinium [MBPyrro]⁺, 1-methyl-1-propyl piperidinium [MPPip]⁺, 1-methyl-1-butyl piperidinium [MBPip]⁺, 1-methyl-1-octylpyrrolidinium [MOPyrro]⁺ and 1-methyl-1-octylpiperidinium [MOPip]⁺.

The polymer separator film (50) may be replaced with an ionically conducting solid, glass or polymer. Solid electrolytes include garnets, nasicons, lisicons, beta alumina or other alkali metal ion conducting solid oxides or sulphide glasses or solids.

The cathode (60) is typically comprised of a cathode active material, a conductive additive such as carbon black, carbon nanotubes, carbon fibres, tungsten carbide, and a polymeric binder such as PTFE, PVDF, CMC, EPDM, SBR, alginate, polyacrylic acid or PEO or any other appropriate polymeric binder material or mixture thereof.

Active material examples of the cathode (60) include layered oxides such as the lithium, sodium or mixed lithium and sodium transition metal oxides. Examples include P₂—NaₓCoO₂, P₂—Na_{2/3}[Ni_{1/3}Mn_{2/3}]O₂, Na_{0.4}MnO₂, NaₓMO₂. Sodium transition metal phosphates or sulfates such as NaFePO₄, NaVPO₄F, Na₃V₂(PO₄)₂F₃, Na₂FePO₄F, Na₃V₂(PO₄)₃, Na₂M₂(SO₄)₃, Na₂M(SO₄)₂, NaMSO₄F and the organic cathode material P(EO)₈NaCF₃SO₃ (polyethylene oxide sodium trifluoromethanesulfonate), Where M is in part a redox active transition metal. Lithium cathode materials include, but not exclusively lithium cobaltate, lithium nickel manganese cobalt oxide, lithium iron phosphate, lithium transition metal sulfates and sulfate fluorides (LiFeSO4F, Li₂Fe₂(SO₄)₃) and lithium vanadium phosphate fluoride.

The cathode current collector (70) is typically an aluminium foil, or carbon coated aluminium foil for lithium and sodium ion batteries. In some cases the current collector may be a carbon paper, or graphite foil.

The anode (40) may for example comprise any one of the materials listed in Table 1 below. The anode current collector (20) is typically copper foil for lithium cells whereas aluminium can be used as well in sodium ion examples. Other examples of current collector include carbon coated aluminium copper or aluminium foil or stainless steel foils. In some cases the current collector may be a carbon paper or graphite foil.

### Example 2

In the cases where the anode (40) is not reactive with the anodic current collector (20) the conductive spacer layer (30) is not required (although may still be provided), however in the cases where the anode material is reactive with the anodic current collector the conductive spacer layer (30) is preferably provided to separate the anode material from the anode current collector. The conductive spacer layer (30) may consist of a coating which has a thickness greater than 1 nm and less than 1000 micrometres. More preferably the conductive spacer layer has a thickness greater than 10 nm and less than 50 micrometres. More preferably the conductive spacer layer has thickness greater than 100 nm and less than 10 micrometres. The conductive spacer layer may be formed of any material which is a solid and is electrically conductive, and forms a protective layer on the current collector. The conductive spacer layer may formed from a carbon material such as carbon black, graphite, carbon nanotubes, graphene, amorphous carbon (hard carbon), other forms of carbon or any mixture of these forms of carbon. In addition the conductive spacer layer may contain a binding agent, for example but not limited to polyvinylidene fluoride, carboxymethyl cellulose, styrene-butadiene rubber, alginates, other binders or any combination thereof.

The conductive spacer layer (30) may be electrochemically active and so contribute to the observed capacity of the anode (although in general the spacer layer will be thin and so make only a small contribution to the overall capacity of the anode). The conductive spacer layer may have a formulation similar to the matrix component of the composite anode layer (40). Alternatively, the conductive spacer layer (30) may have a different composition to the matrix component of the composite anode layer (40), and still contribute to the observed capacity of the anode.

Alternatively, the conductive spacer layer (30) may not be electrochemically active and so may not contribute to the capacity of the anode. The conductive spacer layer (30) may be formed of a material which does not react with the liquid, active component of the composite anode layer (40).

In another embodiment the conductive spacer layer (30) may be formed as a thin coating on the anodic current collector foil (20) via an elemental deposition technique. This may be a chemical vapour deposition (CVD) such as metal-organic vapour phase deposition (MOCVD) or a plasma vapour deposition (PVD) or a physical vapour deposition such as thermal evaporation or electron beam evaporation or a sputter deposition technique. Examples of the protective conductive deposition layer may be metals such as W or Mo, or conductive metal oxides such as lanthanum titanate, indium tin oxide (ITO), indium gallium zirconium oxide (IGZO), or reduced TiO₂ coatings where TiO₂ is deposited and then reduced to form a conductive titanium oxide coating.

Other features of Example 2 are the same as the corresponding features of Example 1.

### Example 3

In another embodiment the composite anode layer (40) is comprised of a supporting matrix (40a) which hosts the liquid electrochemically active anode material/particles (40b). The composite anode (40) may also contain one or more of an electronically conducting additive (40c), a second electrochemically active material (40d) and a binder (40e). The electrode is adhered to a conductive inter-spacer layer (30) upon an anodic current collector (20), as shown in FIG. 3.

The supporting matrix (40a) is a matrix which hosts the liquid electrochemically active anode material (40b), either upon its surface, or in cavities which are integral to the matrix. The supporting matrix (40a) may be comprised of an electronically conducting or an electronically insulating material.

In some embodiments the matrix (40a) may be a non-conducting matrix such as a mesoporous silica material, fumed silica, mesoporous metal oxide, zeolite (such as zeolite A or Faujisute), in this case the matrix material (40a) is also combined with a conductive additive (40c) such as carbon black, carbon nano-tubes, carbon fibres or tungsten carbide to increase the electronic conductivity of the electrode.

In other embodiments the matrix may consist of an electronically conducting material such as carbon black, graphite, carbon nanotubes, graphene, amorphous carbon (hard carbon), mesoporous carbon foam, carbon paper, carbon fibres or other forms of carbon or any mixture of these forms of carbon. In some embodiments where the matrix (40a) consists of an electrically conducting material, an electrically conducting additive such as carbon black or carbon nano tubes may still be provided further to improve the connectivity between the particles.

In some embodiments the matrix (40a) and anodic current collector (20) may be the same component such as a metal foam such as nickel, copper or aluminium—that is, the same component may act as both anode matrix and anode current collector, and the spacer 30 may be omitted.

In some embodiments the composite anode layer may also contain a second electrochemically active anode material in addition to the liquid anode material (40b). If the supporting matrix (40a) comprises an electrochemically active anode material, the second electrochemically active anode material may be constituted by the host matrix (40a). Examples of this include a mesoporous metal oxide material, a nanoporous metal oxide, a hard carbon or amorphous carbon. Alternatively, whether or not the supporting matrix (40a) is electrochemically active, an electrochemically active constituent (40d) may be provided in the matrix, in addition to the liquid anode material (40b), to act as a second electrochemically active anode material.

In some embodiments the components of the anode are held together by a polymeric binder (40e) for example, but not limited to, polyvinylidene fluoride, carboxymethyl cellulose, styrene-butadiene rubber, alginates, other binders or any combination thereof.

As explained, the matrix (40a) includes a liquid, active component (40b). The liquid, active component may consist of any metal or alloy which is a liquid below 100° C. for at least part of the electrochemical charge-discharge cycle of the cell and in addition either inserts, hosts, alloys with or mixes with the metal ions which are shuttling between the cathode and anode. The liquid, active particles (40b) may be a metal or alloy with a melting point below 100° C. The particles (40b) may include at least one of gallium, indium, tin, antimony, bismuth, lead, cadmium, zinc and thallium. Particularly preferred compositions are shown in Table 1. A preferred composition is an alloy containing at least gallium. A further preferred composition is an alloy containing at least gallium and indium and tin—for example Ga_{0.685}In_{0.215}Sn_{0.1} has a melting point of 11° C. The liquid particles (40b) may alternatively consist of other low melting temperature metals or alloys. For example the melting points of some other metals with a melting point below 100° C. are: Hg with a melting point of −39° C., Na with melting point 98° C., K with melting point 64° C., Rb with melting point 39° C. and Cs with melting point 28° C. Alloys of these metals may further lower the melting point. For example some of the binary eutectic combinations are Na₃₁K₆₉ with a melting point of −13° C., Na₁₈Rb₈₂ with a melting point of −4° C. and Na₂₀Cs₈₀ with a melting point of −32° C. Combinations with more than two elements may lower the melting point even further.

Other features of Example 3 are the same as the corresponding features of Example 1.

TABLE 1

| Bismuth | Lead | Tin | Indium | Cadmium | Thallium | Gallium | Antimony |
|---|---|---|---|---|---|---|---|
| <1.5% | | 9.5-10.5% | 21-22% | | | 68-69% | <1.5% |
| | | | 24.5% | | | 75.5% | |
| | | 16% | 22% | | | 62% | |
| 50% | 25% | 25% | | | | | |
| 42.5% | 37.7% | 11.3% | | 8.5% | | | |
| 50% | 26.7% | 13.3% | | 10% | | | |
| 32.5% | | 16.5% | 51% | | | | |
| 49% | 18% | 12% | 21% | | | | |
| 44.7% | 22.6% | 8.3% | 19.1% | 5.3% | | | |
| 40.3 | 22.2 | 10.7 | 17.7 | 8.1 | 1.1 | | |

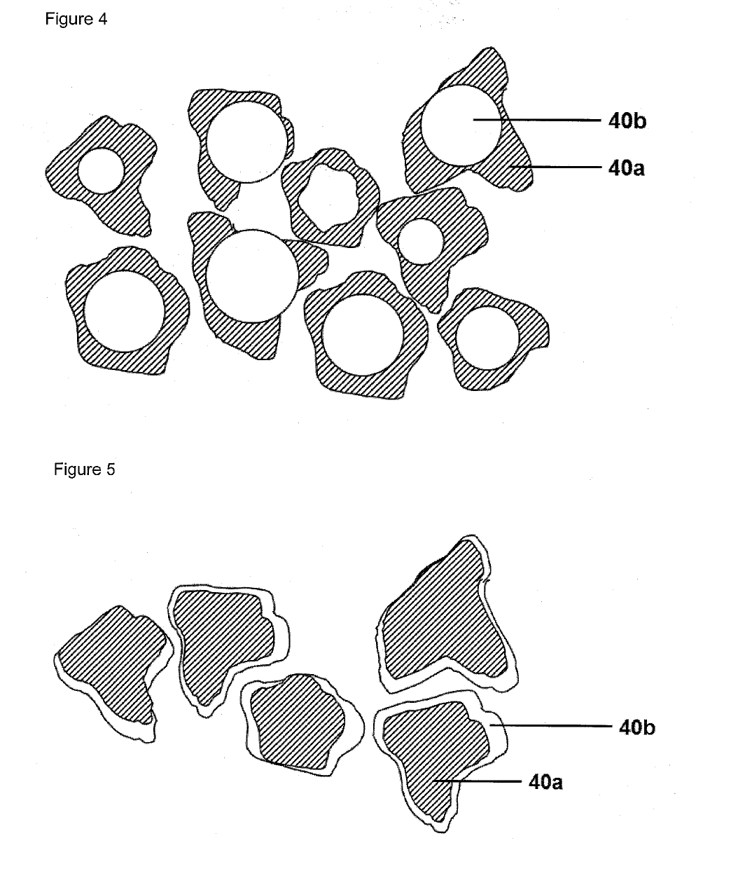

FIGS. 4-18 and 20 illustrate various possible structures for the composite anode layer of an electrode according to an embodiment of the invention, showing the liquid, anodic, active material particles (40b) and the matrix particles (40a). In the composite anode layer (40) in FIGS. 4-18 and 20 it should be assumed that they may also contain at least a conductive additive (40c) and a binder (40e) although for clarity they are not included in the drawings. The composite anode layer (40) may also include other additives, for example as described above.

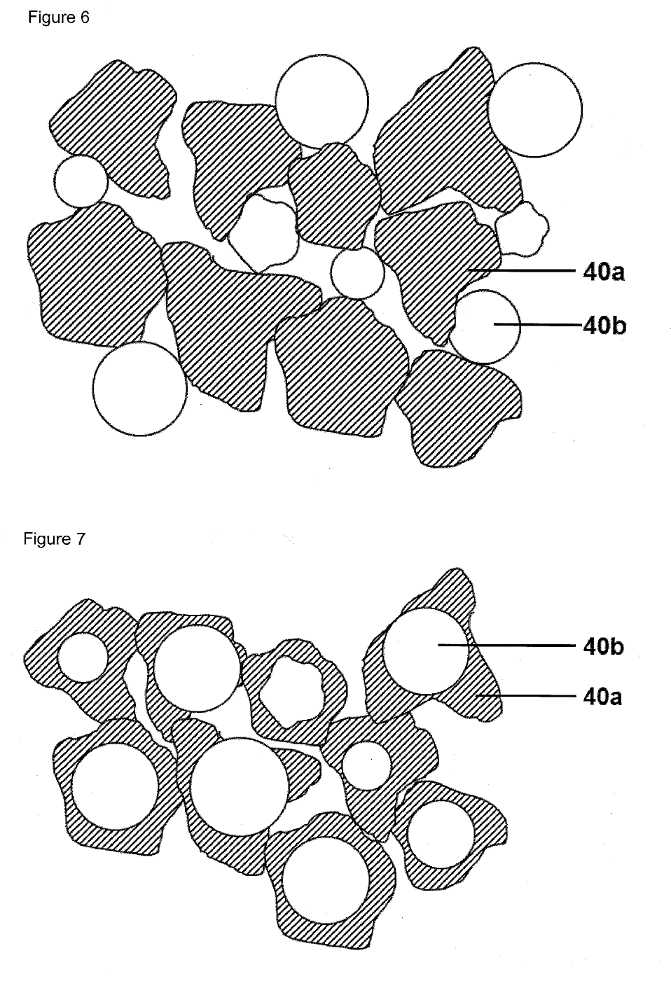

The liquid, anodic, active material particles (40b) may be surrounded by the matrix particles (40a). The matrix particles (40a) may or may not completely enclose the liquid particles (40b) as shown in FIG. 4. The liquid particles (40b) may coat the matrix particles (40a). The liquid particles (40b) may or may not completely enclose the matrix particles (40a) as shown in FIG. 5. The liquid particles (40b) and the matrix particles (40a) may form separate particles within the composite anode layer (40). The composite anode layer (40) may contain any combination of separate and coated particles as shown in FIG. 6 to FIG. 18. The matrix particles (40a) may contain a functional coating to modify the surface properties and change the wetting properties of the liquid particles (40b). The matrix particles (40a) may also be joined into a larger structure to create a mesoporous or macroporous structure in contact with or containing the liquid particles (40b).

FIG. 6 shows a composite anode layer (40) with separate particles of the matrix component (40a) and liquid component (40b).

FIG. 7 shows a composite anode layer (40) with the liquid particles (40b) coated with the matrix component (40a).

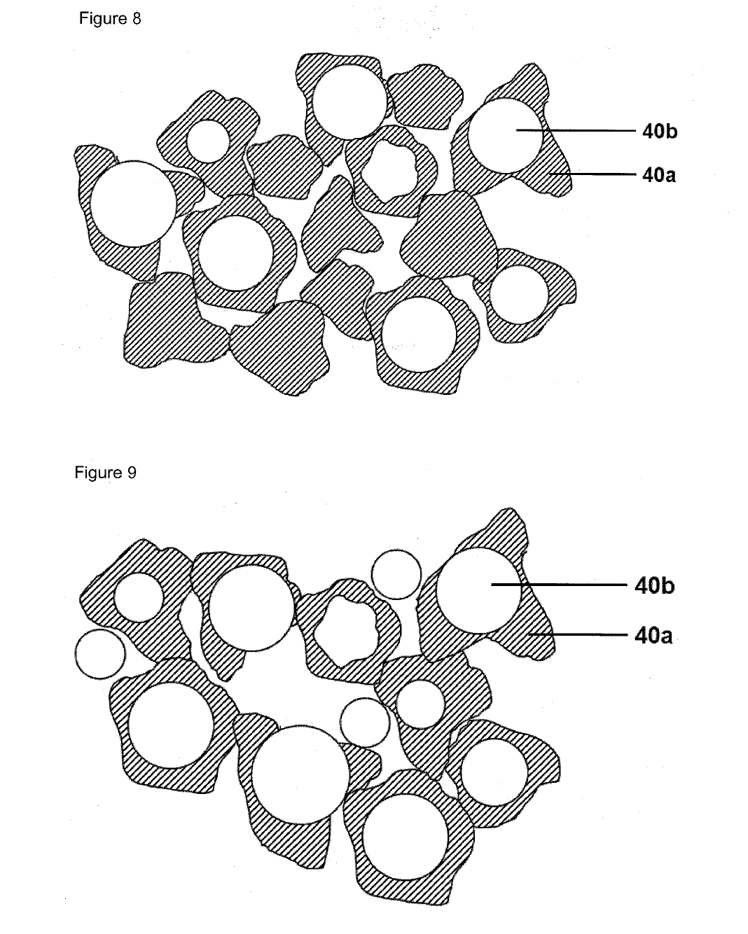

FIG. 8 shows a composite anode layer (40) with the liquid particles (40b) coated with the matrix component (40a) and additionally separate matrix particles (40a).

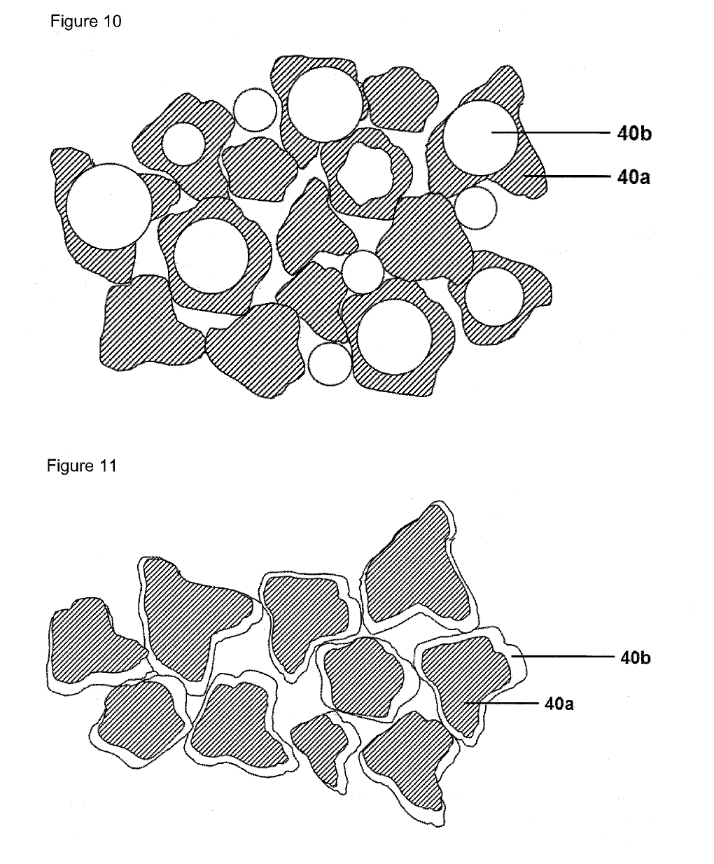

FIG. 9 shows a composite anode layer (40) with the liquid particles (40b) coated with the matrix component (40a) and additionally separate liquid particles (40b).

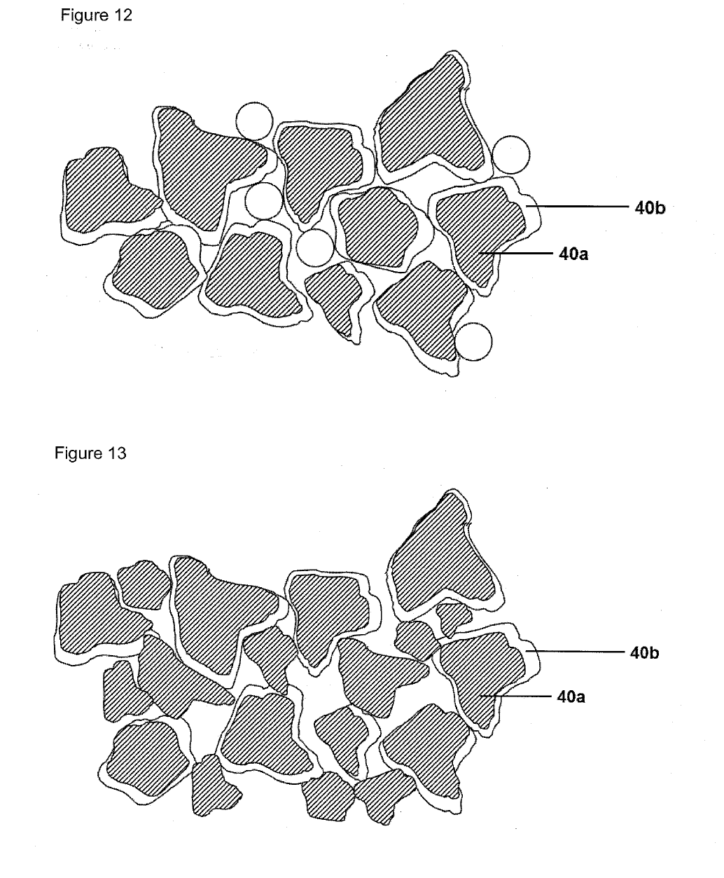

FIG. 10 shows a composite anode layer (40) with the liquid particles (40b) coated with the matrix component (40a) and additionally separate liquid particles (40b) and additionally separate matrix particles (40a).

FIG. 11 shows a composite anode layer (40) with the matrix particles (40a) coated with the liquid component (40b).

FIG. 12 shows a composite anode layer (40) with the matrix particles (40a) coated with the liquid component (40b) and additionally separate liquid particles (40b).

FIG. 13 shows a composite anode layer (40) with the matrix particles (40a) coated with the liquid component (40b) and additionally separate matrix particles (40a).

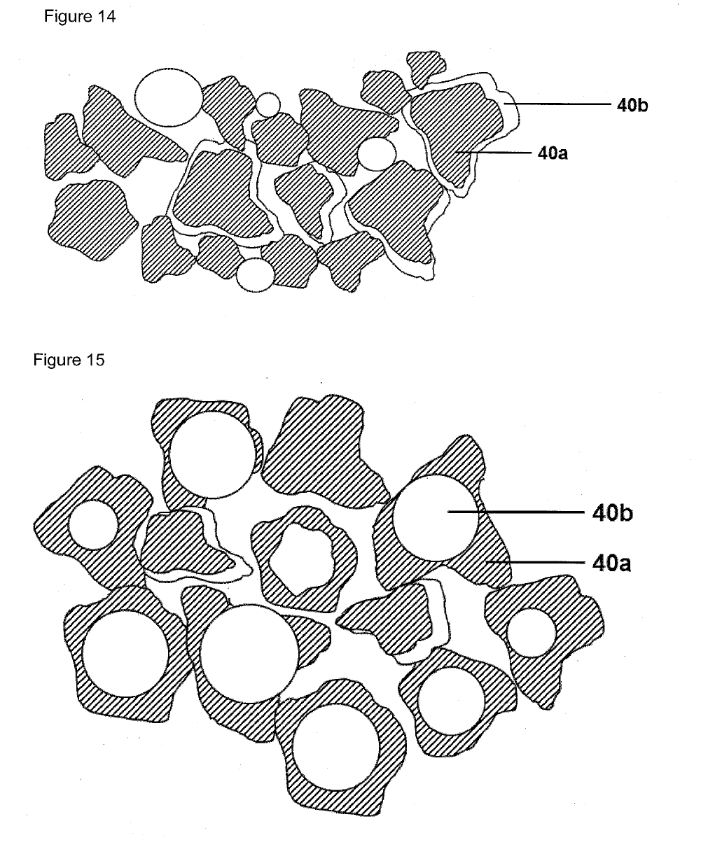

FIG. 14 shows a composite anode layer (40) with the matrix particles (40a) coated with the liquid component (40b) and additionally separate liquid particles (40b) and additionally separate matrix particles (40a).

FIG. 15 shows a composite anode layer (40) with the liquid particles (40b) coated with the matrix component (40a) and additionally the matrix particles (40a) coated with the liquid component (40b).

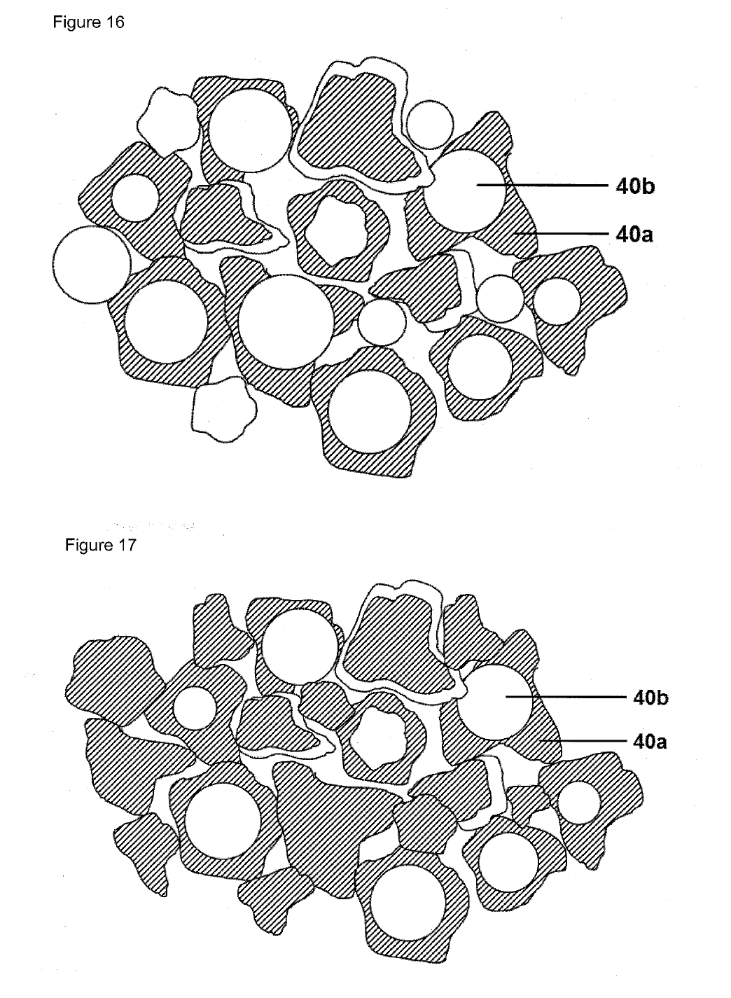

FIG. 16 shows a composite anode layer (40) with the liquid particles (40b) coated with the matrix component (40a) and additionally the matrix particles (40a) coated with the liquid component (40b) and additionally separate liquid particles (40b).

FIG. 17 shows a composite anode layer (40) with the liquid particles (40b) coated with the matrix component (40a) and additionally the matrix particles (40a) coated with the liquid component (40b) and additionally separate matrix particles (40a).

FIG. 18 shows a composite anode layer (40) with the liquid particles (40b) coated with the matrix component (40a) and additionally the matrix particles (40a) coated with the liquid component (40b) and additionally separate liquid particles (40b) and additionally separate matrix particles (40a).

### Example 4

A battery containing a composite anode layer (40) is operated within the temperature range 0° C. to 100° C. A preferred temperature range is between 10° C. and 45° C. A more preferred temperature is the ambient temperature of the environment in which the battery is being used. The battery may be heated to ensure that the liquid component (40b) is a liquid for least part of a charge-discharge cycle of the battery. The heating of the battery may be continuous or the heating may be for a part of a cycle. The heating of the battery may take place only for some of the cycles or for part of some of the charge-discharge cycles of the battery.

### Example 5

The liquid, active particles (40b) may be formed by any suitable method. For example a spray coating technique may be used to form the electrode where the liquid metal or metal alloy (40b) is sprayed onto the anode current collector (20) in conjunction with or alternating with a spray consisting of the matrix material (40a) and any other components of the electrode layer including suitable solvents to make a slurry. This may or may not be an electrospray. This may or may not be a flame spray pyrolysis technique. The metal or metal alloy (40b) may be electrodeposited onto the matrix material (40a). The metal or metal alloy particles (40b) may be in a powder form and mixed with a slurry of the matrix material (40a) and other components at a temperature at which the metal or metal alloy (40b) is a solid. This mixing may be carried out by any suitable mixing method, including but not limited to ball milling, ultrasonic mixing, planetary mixing, centrifugal mixing, dispersion mixing or pulverising. This slurry may then be coated onto the anode current collector (20).

The metal or metal alloy particles (40b) may be either a liquid or a solid and in a dispersion and mixed with a slurry of the matrix material (40a). This mixing method may include a sonication process.

The metal or metal alloy particles (40b) may be in a pure liquid form and be mixed with a slurry of the matrix material (40a). This mixing method may include a sonication process.

The metal or metal alloy particles (40b) may be either a liquid or a solid and have a functional coating in the dispersion. The metal or metal alloy particles (40b) may be a homogenous composition or may consist of a core-shell structure. The metal or metal alloy particles (40b) with a matrix coating (40a) may be synthesised directly in this form, for example from an oxide of the metals with a carbon coating and subsequent carbothermal reduction.

### Example 6

In a preferred embodiment of the present invention at least 1% of the capacity of the composite anode (40) is provided by an electrochemically active matrix material (40a). In a preferred embodiment of the present invention at least 20% of the capacity of the composite anode (40) is provided by the matrix material (40a). In a preferred embodiment the distance between the metal or metal alloy particles (40b) is sufficient that, substantially, particles (40b) in a liquid state do not make contact with other particles (40b) also in a liquid state.

### Example 7

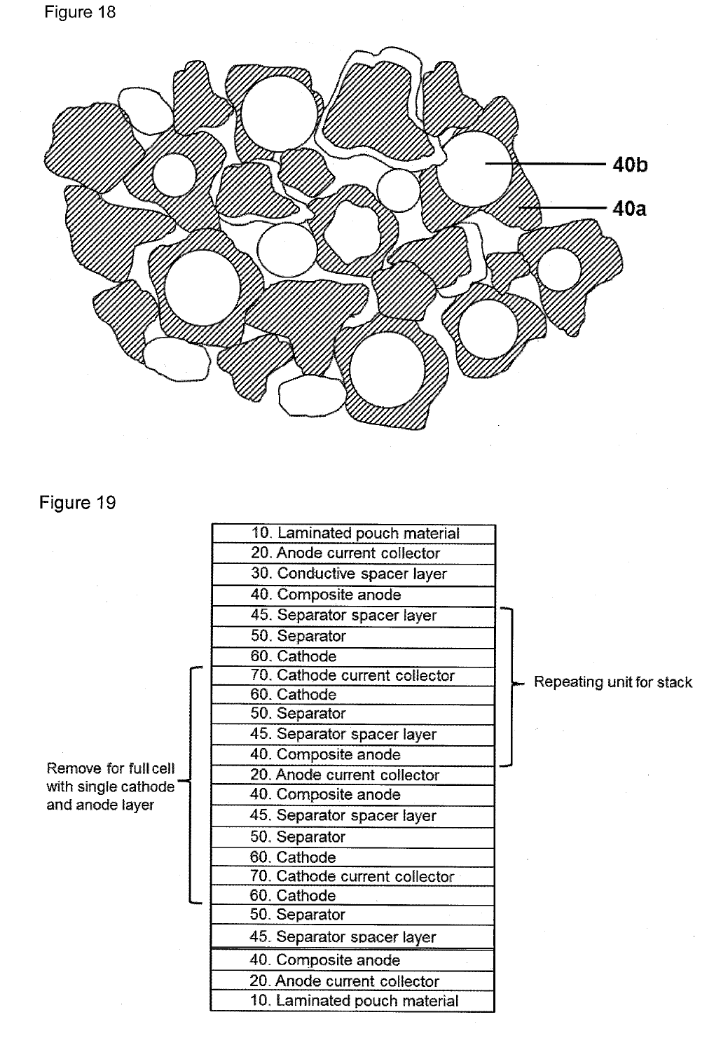

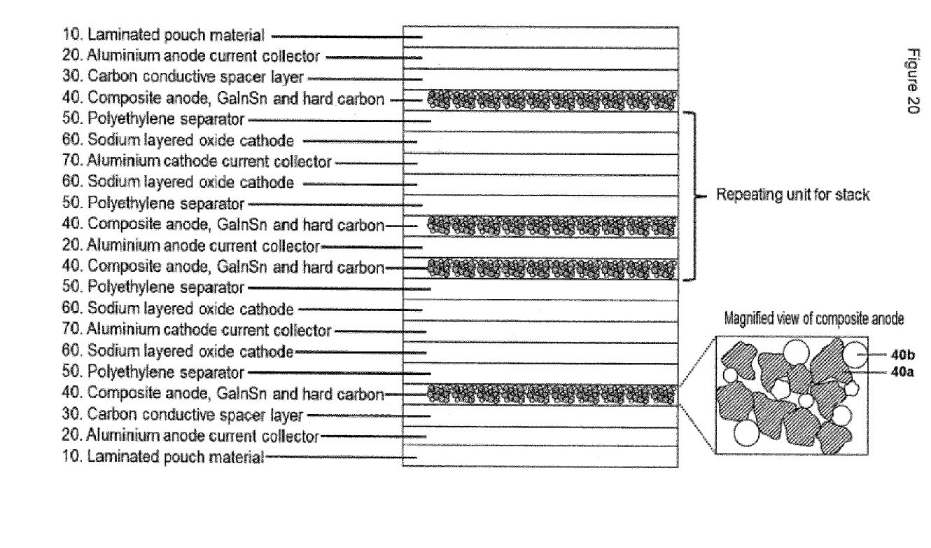

An additional conductive spacer layer (45) may also be included in the cell between the composite anode layer (40) and the separator layer (50) as shown in FIG. 19. It is thought that this layer may provide a benefit to the cell by preventing the liquid component (40b) of the composite anode layer (40) from blocking the pores of the separator layer (50).

The spacer layer (45) may consist of a coating which has a thickness greater than 1 nm and less than 1000 um. More preferably the spacer layer (45) has a thickness greater than 10 nm and less than 50 um. More preferably the spacer layer (45) has thickness greater than 100 nm and less than 10 um. The spacer layer (45) may be formed of any material which is non-metal, is a solid. The spacer layer (45) may formed from a carbon material such as carbon black, graphite, carbon nanotubes, graphene, amorphous carbon (hard carbon), other forms of carbon or any mixture of these forms of carbon. In addition the spacer layer (45) may contain a binding agent, for example but not limited to PTFE (Polytetrafluoroethylene), PVDF (polyvinylidene difluoride), CMC (Carboxymethyl cellulose), EPDM (ethylene propylene diene monomer), SBR (Styrene-butadiene), alginate, polyacrylic acid or PEO (polyethylene oxide), other binders or any combination thereof. The spacer layer (45) may form an active part of the anode and contribute to the capacity of the anode. The spacer layer (45) may have a formulation similar to the matrix component (40a) of the composite anode layer (40). The spacer layer (45) may have a different composition to the matrix component (40a) of the composite anode layer (40). The spacer layer (45) may not form an active part of the anode and may not contribute to the capacity of the anode. The spacer layer (45) may be applied by any appropriate method after the composite anode layer (40). Preferably, the composite anode layer (40) has dried before the application of the spacer layer (45). Suitable application methods include but are not limited to a spray coating, drawdown, comma bar and slot die coating.

### Example 8

An exemplary cell containing an embodiment of the present invention is a sodium ion cell as shown in FIG. 20, with a composite anode formed from a hard carbon matrix (40a) and an alloy (40b) of 10% tin, 21.5% indium and 68.5% gallium. The alloy Ga_{0.685}In_{0.215}Sn_{0.1} has a melting point of 11° C.

In this embodiment the cathode coatings (60) are formed by mixing nickel based sodium layered oxide material with small quantities of a carbon black conductive additive and a PVDF/CTFE (Chlorotrifluoroethylene) copolymer binder with NMP (N-Methyl-2-pyrrolidone) solvent. This slurry is cast onto an aluminium foil cathode current collector (70) and dried. These electrodes are then vacuum dried, cut and calendared before use in the cells. The conductive carbon additive is C65 from TimCal. The ratio of the components is 87% active material, 6% binder and 5% conductive additive.

For the anode coatings (40) a hard carbon (40a) is mixed with NMP, PVDF binder (40c) and a carbon black conductive additive (40e) in a planetary centrifugal mixer. The ratio of the components is 90% hard carbon 5% binder and 5% conductive additive. The matrix material (40a) in this case is electrochemically active, and the matrix material (40a), conductive additive (40e) and polymeric binder (40c) provide a support for the liquid anode material (40b). This slurry is heated to 40° C. in an ultrasonic mixer, a quantity of the alloy Ga_{0.685}In_{0.215}Sn_{0.1} equal to 20% of the weight of the hard carbon component is added and the mixture sonicated to disperse the liquid alloy (40b). This temperature is sufficiently high to ensure the alloy (40b) remains a liquid. This slurry containing the liquid alloy is then cast onto an aluminium current collector (20) which has been previously coated with a conductive carbon spacer layer (30) with a thickness of 1 μm. (In this example the conductive carbon spacer layer (30) is electrochemically active but, for a normal thickness of the spacer layer, the spacer layer may not make a significant contribution to the overall capacity of the anode.) The coatings are then cut and vacuum dried before being assembled into cells. The coatings may be calendared before use to reduce the porosity.

The cells stacks are formed by z-folding a polypropylene separator material (50) between the layers. The cathode current collector layers (70) are welded together ultrasonically with tabbing material, the anode current collector layers (20) are similarly welded together ultrasonically with tabbing material. This stack is placed in a formed pouch of laminated aluminium (10). An electrolyte consisting of a 1M solution of NaPF₆ in an organic solvent mix of EC:DEC (ethylene carbonate and diethyl carbonate) is added to the cell which is subsequently vacuum sealed. When the resultant cell is operated at temperatures above 11° C., for example at “room temperature” (20-30° C.), the Ga_{0.685}In_{0.215}Sn_{0.1} forms the liquid active component (40b) of the anode.

### Example 9

The metal ions which originate in the cathode layer (60) and the electrolyte may be any suitable metal ion including but not limited to Li, Na, Zn, Mg, Al and Ca. In a preferred embodiment the metal ion is lithium. In another preferred embodiment the metal ion is sodium.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

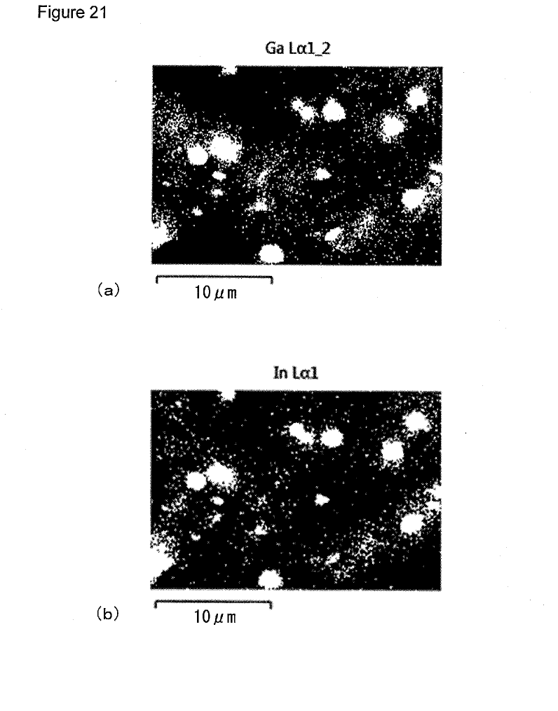

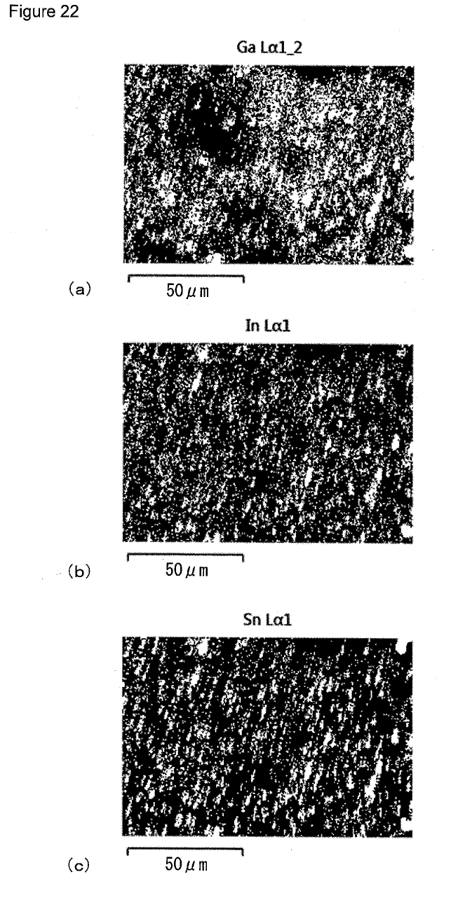

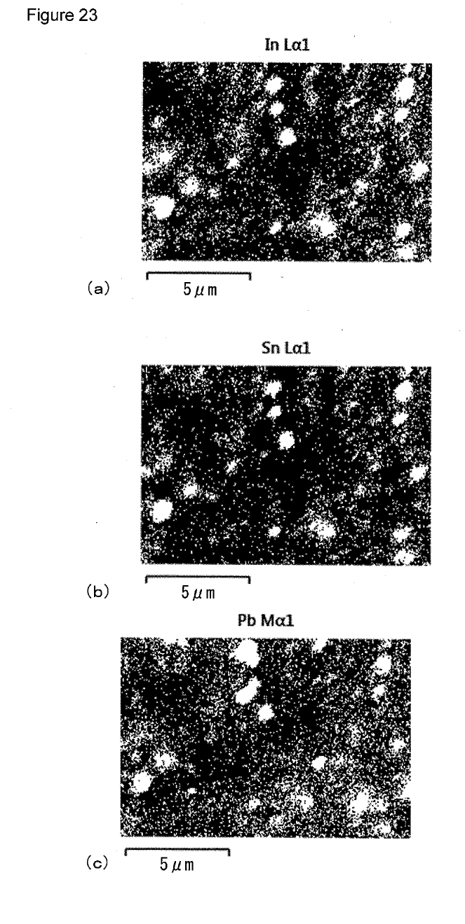

Experimental data for some embodiments of the invention is shown in FIGS. 21-23, showing successful synthesis of three different liquid metal alloy compositions in a carbon matrix. Precursors of sodium alginate were dissolved in water with of tin chloride, gallium acetyl acetate, indium acetate and lead acetate in the correct ratios for the final desired liquid metal alloy. The water is driven off and sodium chloride and an amorphous powder are formed as intermediate products. This mixture is fired above 700° C. under an inert atmosphere to form a metal/carbon composite and sodium chloride. This mixture is then washed in a solvent to remove the sodium chloride leaving behind the desired metal alloy particles embedded in a porous carbon matrix. This method is described in more detail in U.S. Ser. No. 15/189,337. These composites were then examined using energy dispersive X-ray spectroscopy in a scanning electron microscope. This allows elemental analysis of the composite material. The good correlation of the different metal component images of the alloy shows that the metal has been successfully produced as an alloy mixture and these metal alloys would be in liquid from for at least part of the charge-discharge cycle in a battery cell.

(Overview)

One aspect of the present invention describes the use of a liquid component in the anode layer of a metal ion cells with, in some cases, an additional protective and conductive layer between the composite layer containing the liquid component and the current collector. The liquid component consists of a low melting point metal or metal alloy that is liquid for at least some parts of the cell operating cycle and is included in the anode layer in addition to a second electrochemically active component which is a solid at the operating temperature of the battery, and in some cases a conductive additive. A metallic current collector in the metal ion battery may be protected from reacting with the liquid component of the anode by the use of a thin conductive layer which does not contain a liquid component adjacent to the current collector. The presence of the liquid metal component may increase the capacity of the anode layer compared with the capacity of the second electrochemically active component alone. The liquid nature of the liquid component prevents cracks forming in the metal or metal alloy. Cracks are known to form in metal or metal alloy particles during cycling due to the volume expansion with increasing metal-ion content and this may reduce the capacity of the electrode due to loss of electrical contact. The metal or metal alloy only needs to be a liquid for a part of the cycle for this benefit to be realised and therefore may undergo liquid to solid and solid to liquid transitions during a charge-discharge cycle while still maintaining the benefit of one aspect of the present invention. The presence of a conductive layer between the composite anode layer containing the liquid component and a metallic current collector prevents degradation of the current collector due to reactions with the liquid metal or metal alloy. Gallium in particular is quite corrosive and the metals which are resistant to attack are not well suited to use as a current collector due to considerations such as cost and ductility. The use of small particles for the metal or metal alloy particles provides space for volume expansion which may occur as the metal ion content in the anode is increased when the device is charged. The higher surface area of the small particles compared with a bulk film may additionally help with the rate capability of the battery cell as the maximum distance for any metal ion to travel through the bulk of the metal or metal alloy to reach the surface is reduced.

A first aspect of the invention provides a metal-ion electrochemical cell containing a composite anode comprising a support matrix and electrochemically active metal droplets dispersed through the support matrix, the metal droplets having a melting point below 100° C.; a composite cathode containing an intercalation material for the metal ion; and a conducting electrolyte medium located between the anode and the cathode. The metal ion consists of one or more of: sodium, zinc, magnesium, aluminium and calcium.

Use of anode comprising a metal having a melting point below 100° C. ensure that the metal is liquid, over at least part of the charge-discharge cycle of the cell, at operating temperatures lower than this. One aspect of the invention thus provides a cell that obtains the benefits associated with a liquid metal anode component (such as high specific capacity and good reversibility) without needing to be operated at high temperatures. (The reference to the metal being liquid “over at least part of the charge-discharge cycle of the cell” acknowledges that the metal anode material may possibly be incorporated into a solid material at some states of the charge-discharge cycle of the cell),

The cell may further comprise: an anode current collector; and a conductive spacer layer disposed between the anode current collector and the composite anode.

A second aspect of the invention provides a metal-ion electrochemical cell containing: an anode current collector; a composite anode comprising a support matrix and electrochemically active metal droplets dispersed through the support matrix, the metal having a melting point below 100° C.; a composite cathode containing a intercalation material for the metal ion; a conducting electrolyte medium located between the anode and the cathode; and a conductive spacer layer disposed between the anode current collector and the composite anode.

In a cell of the second aspect the metal ion may consist of one or more of: lithium, sodium, zinc, magnesium, aluminium and calcium.

In a cell of the first or second aspect the metal droplets may have a melting point of 50° C. or lower, or may have a melting point of 40° C. or lower. This allows the cell to be operated at lower temperatures. More preferably, in a cell of the first or second aspect the metal droplets may have a melting point of 20° C. or lower, as this allows the cell to be operated at operating temperatures in the range from 20° C. to 30° C. (generally regarded as “room temperature”). Further, in a cell of the first or second aspect the metal droplets may have a melting point of 0° C. or lower, or may even have a melting point as low as −40° C., for example where the cell is intended to be used in a lowtemperature environment.

In a cell of the first or second aspect the conductive spacer layer between the composite anode and the anode current collector may an active part of the anode.

In a cell of the first or second aspect the conductive spacer layer may be formed of essentially the same material as the support matrix of the composite anode.

A cell of the first or second aspect may comprise a separator layer between the composite anode and the composite cathode.

In a cell of the first or second aspect the conducting electrolyte medium may contained in the separator layer.

A cell of the first or second aspect may comprise a second spacer layer between the composite anode and the separator layer.

In a cell of the first or second aspect the composite anode may further comprise a second electrochemically active anode material.

One aspect of the invention may be applied to a cell that contains single anode and a single cathode (forming a cell unit), or it may be applied to a cell stack that consist of multiple cell units. It may also be applied to a cell unit or cell stack that is incorporated into a battery.

To the accomplishment of the foregoing and related ends, the invention, then, comprises the features hereinbefore fully described and particularly pointed out in the claims. The foregoing description and the annexed drawings set forth in detail certain illustrative embodiments of the invention. These embodiments are indicative, however, of but a few of the various ways in which the principles of the invention may be employed. Other objects, advantages and novel features of the invention will become apparent from the foregoing detailed description of the invention when considered in conjunction with the drawings.

This Nonprovisional application claims priority under 35 U.S.C. § 119 on Patent Application No. 1519253.7 filed in Great Britain on Oct. 30, 2015, the entire contents of which are hereby incorporated by reference.

### INDUSTRIAL APPLICABILITY

One aspect of the invention relates to an improvement in metal-ion battery technology and may be applied for use in many different applications such as energy storage devices, rechargeable batteries and electrochemical devices. Advantageously the cells according to an embodiment of the invention increase the capacity of the anode.

1. A metal-ion electrochemical cell containing
a composite anode comprising a support matrix and electrochemically active metal droplets dispersed through the support matrix, the metal droplets having a melting point below 100° C.;
a composite cathode containing an intercalation material for the metal ion; and
a conducting electrolyte medium located between the anode and the cathode;
wherein the metal ion consists of one or more of: sodium, zinc, magnesium, aluminium and calcium.

2. The metal-ion electrochemical cell according to claim 1 and further comprising:
an anode current collector; and
a conductive spacer layer disposed between the anode current collector and the composite anode.

3. A metal-ion electrochemical cell containing
an anode current collector;
a composite anode comprising a support matrix and electrochemically active metal droplets dispersed through the support matrix, the metal droplets having a melting point below 100° C.;
a composite cathode containing a intercalation material for the metal ion;
a conducting electrolyte medium located between the anode and the cathode; and
a conductive spacer layer disposed between the anode current collector and the composite anode.

4. The metal-ion electrochemical cell according to claim 3 wherein the metal ion consists of one or more of: lithium, sodium, zinc, magnesium, aluminium and calcium.

5. The metal-ion electrochemical cell according to claim 1, wherein the metal droplets have a melting point below 40° C.

6. The metal-ion electrochemical cell according to claim 1, wherein the metal droplets having a melting point below 20° C.

7. The metal-ion electrochemical cell according to claim 2, wherein the conductive spacer layer between the composite anode and the anode current collector forms an active part of the anode.

8. The metal-ion electrochemical cell according to claim 2, wherein the conductive spacer layer is formed of essentially the same material as the support matrix of the composite anode.

9. The metal-ion electrochemical cell according to claim 1 further comprising a separator layer between the composite anode and the composite cathode.

10. The metal-ion electrochemical cell according to claim 9 wherein the conducting electrolyte medium is contained in the separator layer.

11. The metal-ion electrochemical cell according to claim 9 further comprising a second spacer layer between the composite anode and the separator layer.

12. The metal-ion electrochemical cell according to claim 1, wherein the composite anode further comprises a second electrochemically active anode material.

13. The metal-ion electrochemical cell according to claim 1, wherein the metal droplets having a melting point above −40° C.

14. The metal-ion electrochemical cell according to claim 1, wherein the metal droplets including at least one of gallium, indium, tin, antimony, bismuth, lead, cadmium, zinc and thallium.
